(19) United States
(12) Patent Application Publication
(10) Pub. No.: US 2024/0215580 A1
(43) Pub. Date: Jul. 4, 2024

(54) MULTI-SOLVENT INSECTICIDAL COMPOSITIONS INCLUDING META-DIAMIDE

(71) Applicant: CLARKE MOSQUITO CONTROL PRODUCTS, INC., St. Charles, IL (US)

(72) Inventors: Laeticia LEROY RENE-BOISNEUF, Naperville, IL (US); Andrea LEVEY, Naperville, IL (US); Kattie Lynne MORRIS, Glendale Heights, IL (US); Yemi Susan BULLEN-MCCLAIN, Vernon Hills, IL (US)

(21) Appl. No.: 18/560,628

(22) PCT Filed: May 16, 2022
(86) PCT No.: PCT/US22/29461

§ 371 Date: Nov. 13, 2023

Related U.S. Application Data
(60) Provisional application No. 63/188,897, filed on May 14, 2021.

(51) Int. Cl. A01N 43/80; A01N 25/02; A01N 37/22; A01P 7/04

(52) U.S. Cl. CPC A01N 43/80; A01N 25/02; A01N 37/22; A01P 7/04

(57) ABSTRACT

Insecticidal compositions may include an active ingredient, a solvent system, and a surfactant. The active ingredient may include a meta-diamide. The solvent system may include a tricarboxylate solvent and a second solvent. The surfactant may be an alkoxylated alcohol. Methods for insect control may include contacting a population of insects with an insecticidal composition. In some aspects, insecticidal compositions are particularly suited for use against mosquitos.

### CROSS-REFERENCE TO RELATED APPLICATION(S)

The present application is related to and claims the priority benefit of U.S. Provisional Patent Application No. 63/188,897, filed May 14, 2021, the entire contents of which are incorporated herein by reference.

### TECHNICAL FIELD

The present disclosure relates to insecticidal compositions and methods of use. More particularly, insecticidal compositions disclosed and contemplated herein include meta-diamide and a multi-solvent system.

### INTRODUCTION

Treatment of adult mosquitoes is an important defense against mosquito-borne illnesses. Typically, adult mosquito populations are controlled with application of pesticides. One common technique uses Ultra-Low Volume (ULV) technology, sometimes referred to as cold fogging. The pesticide is applied with specialized spray equipment mounted in aircraft, on the back of trucks, or even carried by hand. With this technique, aerosols are released to drift through a target zone. Chemical concentrates most often are used, and even if diluted, volumes of material used remain low. Preferably, the aerosol should persist in the air column for an appreciable length of time at suitable droplet densities to contact a flying mosquito. Typically, the aerosol is generally only effective while the droplets remain airborne.

### SUMMARY

In one aspect, an insecticidal composition is disclosed. The insecticidal composition may include an active ingredient including an active ingredient including a meta-diamide, a solvent system including a tricarboxylate solvent and a second solvent, and a surfactant.

In another aspect, a method is disclosed. The method may include emitting an ultra-low volume (ULV) insecticidal composition. The ULV insecticidal composition may include an active ingredient including an active ingredient including a meta-diamide, a solvent system including a tricarboxylate solvent and a polyalkylene solvent, and a surfactant.

There is no specific requirement that a material, technique or method relating to insecticidal compositions include all of the details characterized herein to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 shows experimental laboratory data for mortality rates of Aedes aegypti, Culex, and Anopheles mosquitos 24 hours after being contacted with different insecticidal composition samples.

FIG. 2 shows experimental laboratory data for evaporation rates of samples including different insecticidal compositions that were also subjected to field testing.

### DETAILED DESCRIPTION

Compositions, methods, and techniques disclosed and contemplated herein relate to insecticidal compositions. Insecticidal compositions disclosed herein include a meta-diamide as an active ingredient, which is soluble in few solvents. It was discovered that using multiple-solvent systems including a meta-diamide as the active ingredient provided satisfactory efficacy. Accordingly, insecticidal compositions disclosed herein include multi-solvent systems with suitable solvents. Exemplary insecticidal compositions may have a suitable physical profile and be effective against various species of mosquitoes whether applied aerially or via ground ULV applications.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

“Mosquito” is understood to refer to any specie of the roughly 3,500 species of the insect that is commonly associated with and given the common name “mosquito.” Mosquitoes span 41 insect genera, including the non-limiting examples of Aedes, Culex, Anopheles (carrier of malaria), Coquillettidia, and Ochlerotatus.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. Exemplary Insecticidal Compositions

Exemplary insecticidal compositions may include various components at differing amounts. Exemplary insecticidal compositions may be designed as formulations that can be applied with hand-held, truck-mounted, and aerial ULV sprayers. In some instances, exemplary insecticidal compositions may be ready-to-use formulations that can be applied without dilution. Various aspects of exemplary insecticidal compositions are discussed below.

### A. Various Components of Exemplary Insecticidal Compositions

Exemplary insecticidal compositions include one or more active ingredients and a solvent system. In some instances, exemplary insecticidal compositions may also include one or more surfactants. Exemplary insecticidal compositions may comprise, consist essentially of, or consist of, one or more components disclosed and contemplated herein.

Active ingredients suitable for use in exemplary insecticidal compositions are meta-diamides. A commercially available example of a meta-diamide is Fluxametamide (available as GRACIA® from Nissan Chemical Industries, Ltd.). A structure of fluxametamide is provided below:

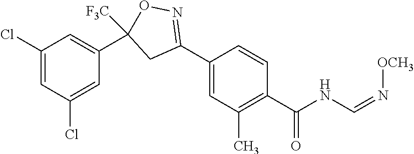 [SMILES: CO/N=C\NC(=O)c1ccc(C2=NOC(c3cc(Cl)cc(Cl)c3)(C(F)(F)F)C2)cc1C]

A commercially available example of a meta-diamide is broflanilide, available as Cimegra sold by BASF (Florham Park, New Jersey). A chemical structure of broflanilide (C₂₅H₁₄BrFnN₂O₂, 3-[benzoyl(methyl)amino]-N-[2-bromo-4-(1,1,1,2,3,3,3-heptafluoropropan-2-yl)-6-(trifluoromethyl)phenyl]-2-fluorobenzamide) is shown below:

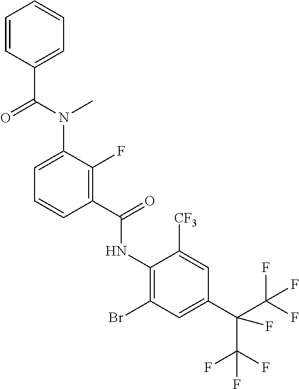 [SMILES: CN(C(=O)c1ccccc1)c1cccc(C(=O)Nc2c(Br)cc(C(F)(C(F)(F)F)C(F)(F)F)cc2C(F)(F)F)c1F]

A commercially available example of a meta-diamide is isocycloseram. A chemical structure of isocycloseram is:

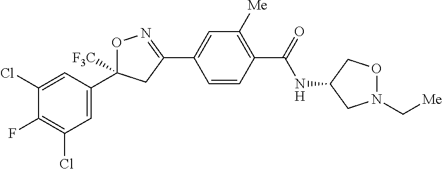 [SMILES: CCN1C[C@H](NC(=O)c2ccc(C3=NO[C@@](c4cc(Cl)c(F)c(Cl)c4)(C(F)(F)F)C3)cc2C)CO1]

Exemplary insecticidal compositions have a solvent system that includes multiple solvents. Typically, exemplary solvent systems use two solvents.

A first solvent is usually a tricarboxylate solvent. Example first solvents may include triethyl citrate. Example first solvents may include canola oil methyl ester, a commercially available example of which includes Steposol ROE-W. Example first solvents may include tributyl O-acetylcitrate (ACBT).

In some instances, suitable second solvents may be carbonates, such as a polyalkylene carbonate. In some instances, the polyalkylene carbonate solvent may be a C₂₋₄ alkylene carbonate. For example, the polyalkylene carbonate solvent may be ethylene carbonate, propylene carbonate, or butane carbonate. In some instances, suitable second solvents may include pentanoic acid. Example second solvents may include methyl 5-(dimethylamino)-2-methyl-5-oxopentanoate, commercially available as Rhodiasolv PolarClean (Solvay). Exemplary second solvents may be a mixture of one or more of the aforementioned exemplary second solvents.

Exemplary insecticidal compositions may include one or more surfactants. Example insecticidal compositions may include an alkoxylated alcohol (also referred to as alcohol alkoxylates) as a surfactant. In some instances, the alkoxylated alcohol (also referred to as an alkoxylate or an alkoxylated aliphatic alcohol) is selected from alkoxylated alcohols of the formula (A)

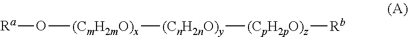

in which R^{a} represents C₅-C₃₆-alkyl, C₅-C₃₆-alkenyl or mixture thereof, preferably linear C₅-C₃₆-alkyl, C₅-C₃₆-alkenyl, or a mixture thereof, in particular linear C₁₄-C₃₆-alkyl, C₁₄-C₃₆-alkenyl, or mixture thereof, or linear C₁₄-C₂₆-alkyl, C₁₄-C₂₆-alkenyl, or mixture thereof, more preferably linear C₁₄-C₂₂-alkyl, or mixture thereof, especially linear C₁₆-C₂₀-alkyl, or mixture thereof; R^{b} represents H or C₁-C₁₂-alkyl, in particular H or C₁-C₄-alkyl, preferably H or methyl, especially H; m, n, p represent, independently of one another, an integer from 2 to 16, preferably from 2 to 5, more preferably 2, 3 or 2 and 3 (in particular 2 and 3); x, y, z represent, independently of one another, a number from 0 to 100, preferably a number from 0 to 30, more preferably from 0 to 20; and x+y+z corresponds to a value from 1 to 100, preferably from 5 to 40, more preferably from 10 to 30 and in particular from 12 to 20.

Commercially available examples of alkoxylated alcohols include the Atplus™ (a C₉-C₁₁ alcohol ethoxylate/propoxylate) product line available from Croda (Edison, NJ), which includes Atplus™ 245. Example surfactants may include polyethylene glycol ether. A commercially available example of polyethylene glycol is Brij™ 02.

### B. Example Amounts of Various Components of Exemplary Insecticidal Compositions

Exemplary insecticidal compositions may include various amounts of various components. For instance, a total amount of active ingredient present in exemplary insecticidal compositions may be between 0.1 wt % (where wt % is percentage by weight) and 6.0 wt %. In various embodiments, a total amount of active ingredient present in exemplary insecticidal compositions may be 0.1 wt % to 5.5 wt %; 0.5 wt % to 5.0 wt %; 1.5 wt % to 6.0 wt %; 2.0 wt % to 6.0 wt %; 2.5 wt % to 5.5 wt %; 1.0 wt % to 5.0 wt %; 1.0 wt % to 4.0 wt %; 2.0 wt % to 5.0 wt %; 3.0 wt % to 6.0 wt %; 1.0 wt % to 3.0 wt %; 2.0 wt % to 4.0 wt %; 3.0 wt % to 5.0 wt %; 4.0 wt % to 6.0 wt %; 0.1 wt % to 1.5 wt %; 0.25 wt % to 3.0 wt %; 0.5 wt % to 1.5 wt %; 0.75 wt % to 1.25 wt %; 1.0 wt % to 2.0 wt %; 2.0 wt % to 3.0 wt %; 3.0 wt % to 4.0 wt %; 4.0 wt % to 5.0 wt %; or 5.0 wt % to 6.0 wt %. In various embodiments, the total amount of active ingredient in exemplary insecticidal compositions may be at least 0.1 wt %; at least 0.25 wt %; at least 0.5 wt %; at least 0.75 wt %; at least 1.0 wt %; at least 2.0 wt %; at least 2.5 wt %; at least 3.0 wt %; at least 4.0 wt %; or at least 5.0 wt %. In various embodiments, the total amount of active ingredient in exemplary insecticidal compositions may be no greater than 6.0 wt %; no greater than 5.5 wt %; no greater than 5.0 wt %; no greater than 4.0 wt %; no greater than 3.0 wt %; no greater than 2.0 wt %; no greater than 1.5 wt %; no greater than 1.25 wt %; no greater than 1.0 wt %; or no greater than 0.5 wt %.

Exemplary insecticidal compositions may include various ratios of solvents. For instance, exemplary insecticidal compositions may include a ratio of tricarboxylate solvent to second solvent of from 0.67:1 to 1.5:1. In various embodiments, exemplary insecticidal compositions may include a ratio of tricarboxylate solvent to second solvent of 0.67:1; of 0.81:1; of 0.9:1; of 0.96:1; of 1:1; of 1.04:1; of 1.1:1; of 1.22:1; or of 1.5:1.

Exemplary insecticidal compositions may include various amounts of solvent system. For instance, exemplary insecticidal compositions may include 70 wt % to 99 wt % solvent system. In various embodiments, a total amount of solvent in exemplary insecticidal compositions may be 70.0 wt % to 99.0 wt %; 74 wt % to 97.0 wt %; 70.0 wt % to 80.0 wt %; 80.0 wt % to 90.0 wt %; 73.0 wt % to 77.0 wt %; 79.0 wt % to 83.0 wt %; 86.0 wt % to 92.0 wt %; 92.0 wt % to 97.0 wt %; or 96.0 wt % to 99.0 wt %. In various embodiments, a total amount of solvent in exemplary insecticidal compositions may be at least 70.0 wt %; at least 74.0 wt; at least 80.0 wt %; at least 85.0 wt %; at least 88.0 wt %; at least 93 wt %; or at least 98 wt %. In various embodiments, a total amount of solvent in exemplary insecticidal compositions may be no greater than 99 wt %; no greater than 92.0 wt %; no greater than 90.0 wt %; no greater than 85.0 wt %; no greater than 82.0 wt %; no greater than 76.0 wt %; or no greater than 73.0 wt %.

Exemplary insecticidal compositions may include various amounts of surfactant, such as from 1.0 wt % to 20.0 wt %. In various embodiments, a total amount of surfactant present in insecticidal compositions may be 1 wt % to 18 wt %; 3 wt % to 20 wt %; 5 wt % to 15 wt %; 1 wt % to 10 wt %; 2 wt % to 7 wt %; 3 wt % to 8 wt %; 4 wt % to 9 wt %; 5 wt % to 10 wt %; 1 wt % to 4 wt %; 4 wt % to 7 wt %; 7 wt % to 10 wt %; 10 wt % to 13 wt %; 13 wt % to 16 wt %; 2 wt % to 4 wt %; 4 wt % to 6 wt %; 6 wt % to 8 wt %; 8 wt % to 10 wt %; 5 wt % to 6 wt %; 6 wt % to 7 wt %; 7 wt % to 8 wt %; 8 wt % to 9 wt %; or 9 wt % to 10 wt %. In various embodiments, a total amount of surfactant present in insecticidal compositions may be at least 1 wt %; at least 2 wt %; at least 3 wt %; at least 5 wt %; at least 6 wt %; at least 7 wt %; at least 8 wt %; at least 9 wt %; at least 10 wt %; at least 13 wt %; at least 16 wt %; or at least 19 wt %. In various embodiments, a total amount of surfactant present in insecticidal compositions may be no greater than 20 wt %; no greater than 17 wt %; no greater than 14 wt %; no greater than 11 wt %; no greater than 10 wt % no greater than 9 wt %; no greater than 8 wt %; no greater than 7 wt %; no greater than 6 wt %; no greater than 4 wt %; or no greater than 2 wt %.

### C. Physical Characteristics of Exemplary Insecticidal Compositions

Exemplary insecticidal compositions may have a suitable physical profile and be effective against various species of mosquitoes whether applied aerially or via ground ULV applications. Typically, it is desirable for the insecticidal composition to persist in the air column for an appreciable length of time at suitable droplet densities to contact a flying mosquito. Characteristics that affect the desired profile include, but are not limited to, non-volatile fraction, density and evaporation rate.

Exemplary insecticidal compositions can be characterized by various physical attributes, such as density, particle size when applied, and non-volatile fraction. Exemplary insecticidal compositions may have a density of from about 1.0 g/mL to about 1.2 g/mL. In various embodiments, exemplary insecticidal compositions may have a density of from 1.0 g/mL to 1.2 g/mL; from 1.0 g/mL to 1.1 g/mL; or from 1.1 g/mL to 1.2 g/mL.

In exemplary embodiments, an insecticidal composition may have a non-volatile fraction from 50 wt % to 100 wt %; from 50 wt % to 75 wt %; or from 50 wt % to 60 wt %. In exemplary embodiments, an insecticidal composition may have a non-volatile fraction of more than about 50 wt %, or more than about 60 wt %, more than about 75 wt %, or more than about 80 wt %. In exemplary embodiments, an insecticidal composition may have a non-volatile fraction of less than about 100 wt %, or less than about 90 wt %, or less than about 75 wt %, or less than about 60 wt %.

In exemplary embodiments, the insecticidal composition can be formulated for application or delivery as an aerosol or a fog, where the insecticidal composition allows for the formation of droplets having an average diameter of less than 30 μm. Suitable insecticidal compositions for such a formulation typically should have a viscosity that allows for the insecticidal composition to atomize, but not be so thick as to clog the nozzle. Such viscosities can vary and be readily determined by one of skill in the art; however, a non-limiting common minimum viscosity is between 0.9 centistokes (cts) to 1.1 centistokes (cts); or about 1 centistokes (cts).

In various implementations, droplets formed of exemplary insecticidal compositions may have an average diameter of 1 μm to 30 μm 5 μm to 25 μm or 8 μm to 22 μm. In exemplary embodiments, droplets formed of exemplary insecticidal compositions may have an average diameter of no less than 1 μm; no less than 5 μm; no less than 8 μm; no less than 12 μm; no less than 16 μm; no less than 20 μm; no less than 24 μm; or no less than 28 μm. In exemplary embodiments, droplets formed of exemplary insecticidal compositions may have an average diameter of no greater than 30 μm; no greater than 26 μm; no greater than 22 μm; no greater than 18 μm; no greater than 14 μm; no greater than 10 μm; no greater than 6 μm; or no greater than 2 μm.

### III. Exemplary Methods of Making

Exemplary insecticidal compositions disclosed and contemplated herein can be generally prepared by any appropriate manufacturing processes and using any appropriate manufacturing equipment such as is known in the art. Exemplary insecticidal compositions can be prepared by combining various components in an appropriate vessel (considering vessel size, amount of insecticidal composition to be made and reactivity of components) with mixing (e.g., stirring) until a uniform or homogeneous insecticidal composition is achieved. Various composition components can be added sequentially, with stirring between each addition to ensure dissolution and/or dispersion of the previous component.

In some instances, a solvent system is prepared before adding any additional components. For instance, a tricarboxylate solvent may be combined with a second solvent to generate a solvent system. After generating the solvent system, an active ingredient may be added to the solvent system. After mixing the active ingredient in the solvent system, one or more surfactants may be added and mixed.

### IV. Exemplary Methods Use

Exemplary insecticidal compositions disclosed and contemplated herein can be used in methods for insect control, where the methods may include contacting an insect or a population of insects with an amount of any of the insecticidal compositions disclosed and contemplated herein. In some embodiments, methods of use may include contacting a mosquito with an amount of an insecticidal composition comprising, consisting essentially of, or consisting of an active ingredient including a meta-diamide, a solvent system including a tricarboxylate solvent and a second solvent, and a surfactant.

In some embodiments, administration of the insecticidal composition provides droplets having an average diameter of less than 30 μm. In some embodiments, the insecticidal composition is applied as an aerosol or fog, and wherein the aerosol or fog contacts the population of insects. In some embodiments, the population of insects comprises mosquitos from one or more of the following genera: Aedes sp., Culex sp., and Anopheles sp.

In some embodiments, the methods described herein can comprise any known route, apparatus, and/or mechanism for the delivery or application of the compositions and formulations. In some embodiments, the method comprises a sprayer. Traditional pesticide sprayers in the pest control markets are typically operated manually or electrically or are gas-controlled and use maximum pressures ranging from 15 to 500 psi generating flow rates from 5 gpm to 40 gpm.

In some embodiments, the methods disclosed herein comprise the use of the compositions and/or formulations in combination with any low volume environmental pest control device(s) such as, for example, ultra-low volume (ULV) machines. Such combinations are useful in methods for mosquito control as well as other flying insects (e.g., flies, gnats, flying ants, sand fleas, and the like) wherein contacting the insect with a low volume of the composition is possible and/or desirable. ULV machines use low volume of material, for example, at rates of about one gallon per hour (or ounces per minute), and typically utilize artificial wind velocities such as from, for example, an air source (e.g., pump or compressor) to break down and distribute the composition/formulation into a cold fog (e.g., having average droplet particle sizes of about 1-30 m). Any standard ground ULV equipment used for adult mosquito control such as, for example, a system including a (CETI) aerosol generator can be used in the methods described herein. A general ULV system includes a tank for the composition (e.g., insecticide), a transport system (e.g., a pump or pressurized tank), a flow control device, and a nozzle that atomizes the composition. Typically, ULV machines do not compress droplets. Rather, they often use a venture siphoning system, and can induce an artificial energizing of the droplets by adding an electrical current to the liquid (e.g., through the use an electrode located at the application tip. (See, e.g., U.S. Pat. No. 3,516,608 (Bowen, et al.) incorporated herein by reference.)

In some embodiments, contacting a population of insects with insecticidal compositions disclosed and contemplated herein results in a mortality rate of at least 70% against each of Aedes sp., Culex sp., and Anopheles sp. after 48 hours. In some embodiments, contacting a population of insects with insecticidal compositions disclosed and contemplated herein results in a mortality rate of at least 80% against each of Aedes sp., Culex sp., and Anopheles sp. after 48 hours. In some embodiments, contacting a population of insects with insecticidal compositions disclosed and contemplated herein results in a mortality rate of at least 80% against each of Aedes sp., Culex sp., and Anopheles sp. after 24 hours. In some embodiments, contacting a population of insects with insecticidal compositions disclosed and contemplated herein results in a mortality rate of at least 90% against each of Aedes sp., Culex sp., and Anopheles sp. after 48 hours. In some embodiments, contacting a population of insects with insecticidal compositions disclosed and contemplated herein results in a mortality rate of at least 90% against each of Aedes sp., Culex sp., and Anopheles sp. after 24 hours.

### V. Experimental Examples

Experimental examples were conducted and the results are discussed below.

### A. Laboratory Experimental Analysis

In a laboratory environment, three different insecticidal compositions were evaluated, termed DOE 1, DOE 2, and DOE 3. Composition specifics for DOE 1, DOE 2, and DOE 3 are provided below in Table 1.

TABLE 1
DOE 1, DOE 2, and DOE 3 compositions experimentally tested.

| | DOE 1 | DOE 2 | DOE 3 |
|---|---|---|---|
| Components | Nominal wt % | Nominal wt % | Nominal wt % |
| Broflanilide | 1.00% | 1.00% | 1.00% |
| Atplus 245 | 11.25% | 0.00% | 1.50% |
| Brij O2 | 3.75% | 0.00% | 1.50% |
| Triethyl Citrate | 36.00% | 33.00% | 33.00% |
| Steposol ROE-W | 48.00% | 66.00% | 63.00% |

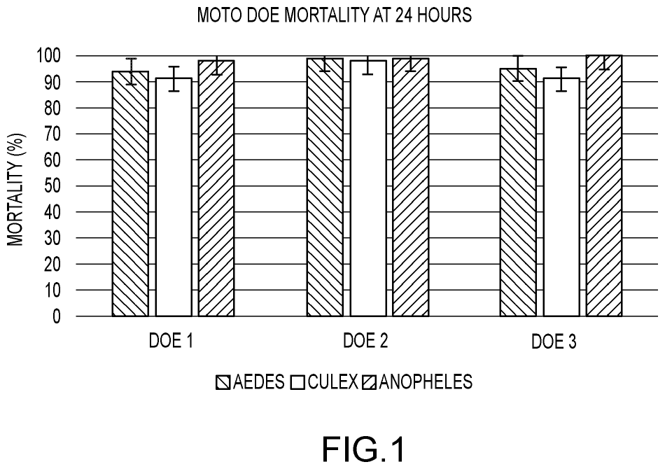

Samples of DOE 1, DOE 2 and DOE 3 were applied to Aedes aegypti, Culex quinquefasciatus, and Anopheles quadrimaculatus mosquitoes. FIG. 1 shows mortality rates after 24 hours for each composition.

Evaporation profile tests were conducted on Composition 4 and Composition 5, detailed in Table 2 below.

TABLE 2
Composition 4 and Composition 5 constituents.

| | Composition 4 | Composition 5 |
|---|---|---|
| Components | Nominal wt % | Nominal wt % |
| Broflanilide | 1.00% | 1.00% |
| Atplus 245 | 2.50% | — |
| Propylene Carbonate | 19.20% | — |
| Polarclean | — | 33.00% |
| Tributyl O-acetylcitrate | 77.30% | 66.00% |

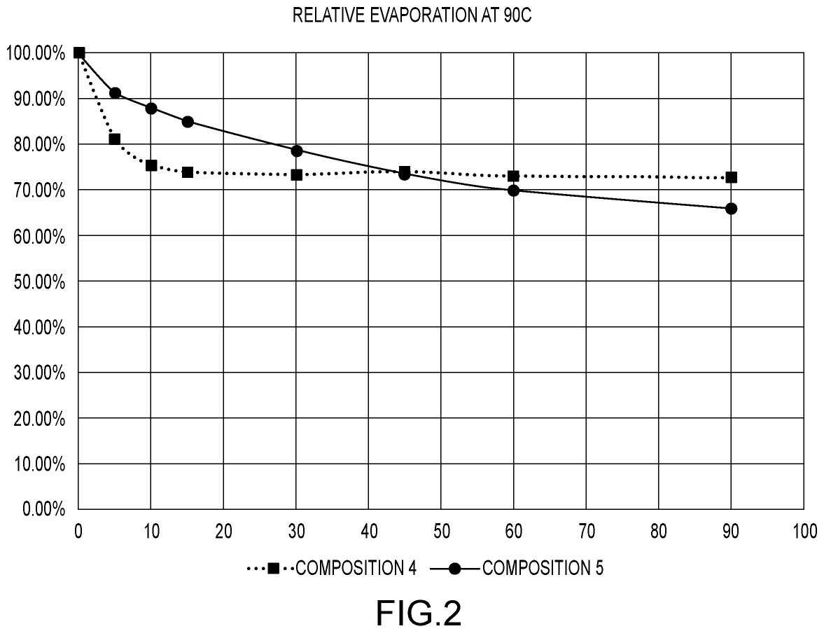

Results of the evaporation test, conducted at 90° C., are shown in FIG. 2 and Table 3 below.

TABLE 3
Evaporation rates at 90° C. for Composition 4 and Composition 5.

| Minutes | Composition 4 | Composition 5 |
|---|---|---|
| 0 | 100.00% | 100.00% |
| 5 | 81.17% | 91.18% |
| 10 | 75.44% | 88.02% |
| 15 | 73.88% | 84.95% |
| 30 | 73.40% | 78.72% |
| 45 | 74.08% | 73.63% |
| 60 | 73.01% | 69.89% |
| 90 | 72.72% | 66.06% |

### B. Field Trials

Field trials were conducted for insecticidal Composition 4 at various locations. The objective of the studies was to determine the efficacy of Composition 4 in open field caged trials against adult Aedes aegypti, Anopheles quadrimaculatus, and Culex quinquefasciatus. Aedes aegypti and Culex quinquefasciatus were tested at Polk County, FL, Beaufort County, SC, Maricopa County, A Z, and Baytown, TX. Anopheles quadrimaculatus was tested at Polk County, FL, Beaufort County, S C, and Baytown, TX.

The Composition was applied using truck-mounted ultra-low-volume (ULV) cold aerosol spray equipment: using a Clarke Cougar™ IHPLAT Nozzle, Smart Flow System for Polk County, FL and Beaufort County, SC; and using a Clarke Grizzly™ IHPLAT Nozzle, Smart Flow System for Maricopa County, A Z and Baytown, TX. The trials were conducted at an application rate of 0.75 oz./acre and in accordance with EPA Product Performance Test Guidelines OPPTS 810.3400—Mosquito, Black Fly, and Biting Midge (Sand Fly) Treatments.

Mosquitoes used during the study were two- to six-day old adult females Aedes aegypti, Anopheles quadrimaculatus, and Culex quinquefasciatus. Pupae were provided by the Clarke insectary for the bioassay, the mosquitoes were reared and emerged in cages stored in a secure, temperature-controlled location. They were fed a 10% to 20% sugar water solution throughout the study period. The mosquitoes were visually inspected for accurate species and gender identification and viability.

Approximately 15-30 mosquitoes were mouth-aspirated using aspirators with HEPA-filters into standard cylindrical cardboard spray cages (14.4 cm diameter by 3.81 cm wide) or holding cages. (Townzen, K. R. et al., 1973). Mosquito cages were then placed in an enclosed container and stored in a secure environment until placed in field for evaluation.

The treatment site consisted of an open grassy field large enough for a 1000-foot spray tangent and a 300-foot swath. Rotary slide impingers with Teflon-coated slides were placed on stakes adjacent to spray cages at 100, 200 and 300 feet of each replicate. Spray cages were placed on five-foot stakes, (three cages per stake, one cage per species), at an angle perpendicular to the spray line. Stakes were placed at 100, 200 and 300 feet down-wind at a 90° angle from the spray line. Cages were placed in one column 100 feet apart. A total of nine spray cages per species were used for each replicate, and one control cage per species was used per application rate (three replicates).

Teflon coated slides were used to sample the spray cloud at 100, 200, and 300 feet down wind of the spray truck tangent using Leading Edge Slide Impingers. Droplets were collected in each replicate and analyzed using a spread factor of 0.71 (Anderson, C. H. et al., 1971; May, K. R et al., 1950).

A Kestrel meteorological station was placed on site at a 30 foot elevation at the start of the trials to confirm temperature inversion. An additional Kestrel meteorological station was placed at five feet, including wind direction, wind speed, temperature, and relative humidity. Data was recorded at one-minute intervals after initial insecticide release (Christensen, P. W. et al., 1972).

A total of three replications per application rate were made for this trial. Following each spray, the treated mosquitoes were allowed ten minutes of exposure and then transferred to clean holding cages for mortality monitoring.

Mosquitoes were monitored at 12, 24, 48, 72 and 96 hours for mortality. For the mortality ratings, any movement by a mosquito required the observer to record the individual as alive.

Untreated control cages were used per three replicates. Control cages were placed upwind from the spray tangent during treatments to protect from contamination and were handled in a manner identical to treated mosquitoes.

1. Tests for Aedes aegypti

Twelve total spray replicates of Composition 4 were performed against Aedes aegypti female mosquitoes for this study. These spray replicates were conducted across four spatially distanced study locations: Polk County, FL, Beaufort County, SC, Maricopa County, A Z, and Baytown, TX.

Droplet size was 14.2 μm at Polk County, FL and Beaufort County, SC, 17.4 μm at Maricopa County, AZ, and 13.7 μm at Baytown, TX.

Volume median diameter (VMD) and droplet densities (drops per square centimeter) were determined for 100 feet, 200 feet, and 300 feet distances following spray of Composition 4. Results are shown in Table 4.

TABLE 4
Average droplet size (VMD) and drop densities
for Composition 4 at the various field sites.

| | | | Volume | |
|---|---|---|---|---|
| | | | Median | |
| Site | | Distance | Diameter | Droplet |
| (Replicate) | Location | (ft) | (VMD) | Density |
| Bartow A | 1 | 100 | 26.3 | 246 |
| | 2 | 100 | 18.1 | 381.3 |
| | 3 | 100 | 22.3 | 319.8 |
| | 4 | 200 | 20.3 | 504.3 |
| | 5 | 200 | 23.7 | 180.4 |
| | 7 | 300 | 21.1 | 401.8 |
| | 9 | 300 | 22.5 | 565.8 |
| | Control | n/a | 0 | 0 |
| Lake Wales A | 1 | 100 | 17.2 | 1615.3 |
| | 3 | 100 | 16.3 | 672.4 |
| | 5 | 200 | 20.2 | 1106.9 |
| | 7 | 300 | 16.9 | 860.9 |
| | 9 | 300 | 17.3 | 643.7 |
| | Control | n/a | 3.9 | 49.2 |
| Lake Wales B | 1 | 100 | 18.3 | 512.5 |
| | 3 | 100 | 18.2 | 778.9 |
| | 5 | 200 | 19.7 | 205 |
| | 7 | 300 | 15.4 | 272.6 |
| | 8 | 300 | 17.7 | 373.1 |
| | Control | n/a | 3.3 | 6.8 |
| Beaufort A | 1 | 100 | 17.3 | 770.7 |
| | 3 | 100 | 17.7 | 278.8 |
| | 5 | 200 | 16.9 | 172.2 |
| | 6 | 200 | 16.8 | 83.4 |
| | 7 | 300 | 15.6 | 260.3 |
| | 9 | 300 | 15.3 | 207.0 |
| | Control | n/a | 3.3 | 57.4 |
| Beaufort B | 1 | 100 | 18.5 | 169.5 |
| | 3 | 100 | 16.0 | 147.6 |
| | 4 | 200 | 17.3 | 102.5 |
| | 5 | 200 | 16.4 | 76.5 |
| | 6 | 200 | 17.4 | 73.8 |
| | 7 | 300 | 19.6 | 91.6 |
| | 8 | 300 | 16.8 | 87.5 |
| | 9 | 300 | 19.9 | 64.2 |
| | Control | n/a | 0.0 | 0 |
| Beaufort C | 1 | 100 | 22.3 | 414.1 |
| | 3 | 100 | 22.2 | 131.2 |
| | 5 | 200 | 23.1 | 117.5 |
| | 6 | 200 | 18.7 | 116.2 |
| | 8 | 300 | 18.9 | 56.0 |
| | 9 | 300 | 22.4 | 183.1 |
| | Control | n/a | 10.3 | 9.6 |
| Maricopa A | 1 | 100 | 18.5 | 251.4 |
| | 3 | 100 | 21.7 | 840.4 |
| | 5 | 200 | 21.0 | 926.5 |
| | 7 | 300 | 19.1 | 243.9 |
| | 8 | 300 | 22.3 | 159.9 |
| | 9 | 300 | 20.2 | 187.2 |
| | Control | n/a | 3.6 | 51.9 |
| Maricopa B | 1 | 100 | 20.8 | 153.1 |
| | 2 | 100 | 22.5 | 91.6 |
| | 3 | 100 | 22.5 | 219.3 |
| | 5 | 200 | 20.3 | 975.7 |
| | 7 | 300 | 20.2 | 42.4 |
| | 8 | 300 | 20.0 | 95.7 |
| | 9 | 300 | 19.3 | 280.8 |
| | Control | n/a | 0.0 | 0.0 |
| Maricopa C | 1 | 100 | 24.9 | 225.5 |
| | 3 | 100 | 20.4 | 254.2 |
| | 5 | 200 | 17.9 | 297.2 |
| | 7 | 300 | 19.3 | 221.4 |
| | 9 | 300 | 19.7 | 284.9 |
| | Control | n/a | 0.0 | 0.0 |
| Baytown A | 1 | 100 | 16.8 | 1041.3 |
| | 3 | 100 | 19.0 | 701.1 |
| | 5 | 200 | 17.5 | 651.9 |
| | 7 | 300 | 20.7 | 385.4 |
| | 9 | 300 | 21.0 | 504.3 |
| | Control | n/a | 6.3 | 113.4 |
| Baytown B | 1 | 100 | 9.9 | 231.6 |
| | 3 | 100 | 17.9 | 1045.4 |
| | 5 | 200 | 18.3 | 668.3 |
| | 7 | 300 | 12.0 | 594.5 |
| | 9 | 300 | 12.8 | 420.2 |
| | Control | n/a | 5.1 | 195.4 |
| Baytown C | 1 | 100 | 17.9 | 754.3 |
| | 3 | 100 | 16.4 | 819.9 |
| | 5 | 200 | 21.2 | 434.6 |
| | 7 | 300 | 23.2 | 508.4 |
| | 9 | 300 | 17.3 | 446.9 |
| | Control | n/a | 11.8 | 43.7 |

Tables 5, 6, 7 and 8 below show mean mortality and median mortality results for application of Composition 4 to Aedes aegypti female mosquitos at the four field sites.

TABLE 5
Cumulative efficacy data for all spray replicates at Polk
County, FL against Aedes aegypti female mosquitoes.

| | |
|---|---|
| Mean Mortality¹ | Median Mortality |

| Distance | 24-hour | 48-hour | 24-hour | 48-hour |
|---|---|---|---|---|
| 100 ft | 89%^{a} | 100%^{a} | 88% | 100% |
| 200 ft | 86%^{a} | 100%^{a} | 86% | 100% |
| 300 ft | 84%^{a} | 97%^{b} | 92% | 100% |
| Untreated Control | 3%^{b} | 4%^{c} | 0% | 4% |
| (upwind) | | | | |

| | |
|---|---|
| Overall Average (at | 99% |

48 hours)

TABLE 6
Cumulative efficacy data for all spray replicates at Beaufort
County, SC against Aedes aegypti female mosquitoes.

| | Mean Mortality | | | Median Mortality | | |
|---|---|---|---|---|---|---|
| Distance | 24-hour | 48-hour | 72-hour | 24-hour | 48-hour | 72-hour |
| 100 ft | 82%^{a} | 98%^{a} | 100%^{a} | 83% | 100% | 100% |
| 200 ft | 44%^{b} | 82%^{b} | 97%^{a} | 37% | 93% | 100% |
| 300 ft | 31%^{c} | 86%^{c} | 95%^{b} | 11% | 83% | 93% |
| Untreated Control | 1% | 2% | 2%^{c} | 0% | 0% | 0% |
| (upwind) | | | | | | |

| | |
|---|---|
| Overall Average | 97% |
| (at 72 hours) | |

TABLE 7
Cumulative efficacy data for all spray replicates for Maricopa
County, AZ against Aedes aegypti female mosquitoes.

| | Mean Mortality¹ | | | Median Mortality | | |
|---|---|---|---|---|---|---|
| Distance | 24-hour | 48-hour | 72-hour | 24-hour | 48-hour | 72-hour |
| 100 ft | 69%^{a} | 98%^{a} | 100%^{a} | 74% | 100% | 100% |
| 200 ft | 78%^{b} | 100%^{a} | 100%^{a} | 79% | 100% | 100% |
| 300 ft | 59%^{c} | 88%^{b} | 94%^{b} | 71% | 100% | 100% |
| Untreated Control | 2%^{d} | 3%^{c} | 3%^{c} | 0% | 4% | 4% |
| (upwind) | | | | | | |

| | |
|---|---|
| Overall Average | 98% |
| (at 72 hours) | |

TABLE 8
Cumulative efficacy data for all spray replicates for
Baytown, TX against Aedes aegypti female mosquitoes.

| | Mean Mortality¹ | | | Median Mortality | | |
|---|---|---|---|---|---|---|
| Distance | 24-hour | 48-hour | 72-hour | 24-hour | 48-hour | 72-hour |
| 100 ft | 65%^{a} | 92%^{a} | 98%^{a} | 74% | 100% | 100% |
| 200 ft | 71%^{a} | 96%^{ab} | 100%^{b} | 71% | 96% | 100% |
| 300 ft | 68%^{a} | 99%^{b} | 100%^{b} | 65% | 100% | 100% |
| Untreated Control | 2%^{b} | 6%^{c} | 6%^{c} | 0% | 5% | 4% |
| (upwind) | | | | | | |

| | |
|---|---|
| Overall Average | 99% |
| (at 72 hours) | |

With all spray replicates across all locations included in analysis, the average mortality at 72 hours post-spray was 99.3% for spray cages placed 100 feet from the spray line, 99.4% for 200 feet and 96.3% for 300 feet. Across all spray replicates and distances, overall mortality was 98.3%. Control mortality averaged 3.8% at 72 hours. If reading were halted at 48 hours, the 48-hour mortality values are included in the 72-hour efficacy averages. Results are shown in Table 9 below.

TABLE 9
Efficacy of Composition 4 against Aedes aegypti female mosquitoes.

| | 24 hours | | 48 hours | | 72 hours | |
|---|---|---|---|---|---|---|
| Distance | Mortality | Moribund | Mortality | Moribund | Mortality | Moribund |
| All | 68.4% | 86.5% | 94.5% | 96.8% | 98.3% | 98.9% |
| 100 | 76.3% | 92.4% | 97.0% | 98.3% | 99.3% | 99.8% |
| 200 | 69.4% | 89.5% | 94.2% | 97.1% | 99.3% | 99.5% |
| 300 | 59.5% | 77.5% | 92.3% | 95.0% | 96.3% | 97.5% |

| | | | |
|---|---|---|---|
| Control | 1.8% | 3.6% | 3.8% |

2. Tests for Anopheles quadrimaculatus

Nine total spray replicates of Composition 4 were performed against Anopheles quadrimaculatus female mosquitoes for this study. These spray replicates were conducted across three spatially distanced study locations: Polk County, FL, Beaufort County, S C, and Baytown, TX.

Droplet size was 14.2 μm at Polk County, FL and Beaufort County, SC, and 13.7 μm at Baytown, TX.

Volume median diameter (VMD) and droplet densities (drops per square centimeter) were determined for 100 feet, 200 feet, and 300 feet distances following spray of Composition 4. Results are shown in Table 10.

TABLE 10
Droplet data for spray replicates.

| | | | Volume | |
|---|---|---|---|---|
| | | | Median | |
| Site | | Distance | Diameter | Droplet |
| (Replicate) | Location | (ft) | (VMD) | Density |
| Polk | 1 | 100 | 26.3 | 246 |
| County, FL | 2 | 100 | 18.1 | 381.3 |
| A | 3 | 100 | 22.3 | 319.8 |
| | 4 | 200 | 20.3 | 504.3 |
| | 5 | 200 | 23.7 | 180.4 |
| | 7 | 300 | 21.1 | 401.8 |
| | 9 | 300 | 22.5 | 565.8 |
| | Control | n/a | 0 | 0 |
| Polk | 1 | 100 | 17.2 | 1615.3 |
| County, FL | 3 | 100 | 16.3 | 672.4 |
| B | 5 | 200 | 20.2 | 1106.9 |
| | 7 | 300 | 16.9 | 860.9 |
| | 9 | 300 | 17.3 | 643.7 |
| | Control | n/a | 3.9 | 49.2 |
| Polk | 1 | 100 | 18.3 | 512.5 |
| County, FL | 3 | 100 | 18.2 | 778.9 |
| C | 5 | 200 | 19.7 | 205 |
| | 7 | 300 | 15.4 | 272.6 |
| | 8 | 300 | 17.7 | 373.1 |
| | Control | n/a | 3.3 | 6.8 |
| Beaufort | 1 | 100 | 17.3 | 770.7 |
| County, SC | 3 | 100 | 17.7 | 278.8 |
| B | 5 | 200 | 16.9 | 172.2 |
| | 6 | 200 | 16.8 | 83.4 |
| | 7 | 300 | 15.6 | 260.3 |
| | 9 | 300 | 15.3 | 207.0 |
| | Control | n/a | 3.3 | 57.4 |
| Beaufort | 1 | 100 | 18.5 | 169.5 |
| County, SC | 3 | 100 | 16.0 | 147.6 |
| | 4 | 200 | 17.3 | 102.5 |
| | 5 | 200 | 16.4 | 76.5 |
| | 6 | 200 | 17.4 | 73.8 |
| | 7 | 300 | 19.6 | 91.6 |
| | 8 | 300 | 16.8 | 87.5 |
| | 9 | 300 | 19.9 | 64.2 |
| | Control | n/a | 0.0 | 0 |
| Beaufort | 1 | 100 | 22.3 | 414.1 |
| County, SC | 3 | 100 | 22.2 | 131.2 |
| C | 5 | 200 | 23.1 | 117.5 |
| | 6 | 200 | 18.7 | 116.2 |
| | 8 | 300 | 18.9 | 56.0 |
| | 9 | 300 | 22.4 | 183.1 |
| | Control | n/a | 10.3 | 9.6 |
| Baytown, | 1 | 100 | 16.8 | 1041.3 |
| TX | 3 | 100 | 19.0 | 701.1 |
| A | 5 | 200 | 17.5 | 651.9 |
| | 7 | 300 | 20.7 | 385.4 |
| | 9 | 300 | 21.0 | 504.3 |
| | Control | n/a | 6.3 | 113.4 |
| Baytown, | 1 | 100 | 9.9 | 231.6 |
| TX | 3 | 100 | 17.9 | 1045.4 |
| B | 5 | 200 | 18.3 | 668.3 |
| | 7 | 300 | 12.0 | 594.5 |
| | 9 | 300 | 12.8 | 420.2 |
| | Control | n/a | 5.1 | 195.4 |
| Baytown, | 1 | 100 | 17.9 | 754.3 |
| TX | 3 | 100 | 16.4 | 819.9 |
| C | 5 | 200 | 21.2 | 434.6 |
| | 7 | 300 | 23.2 | 508.4 |
| | 9 | 300 | 17.3 | 446.9 |
| | Control | n/a | 11.8 | 43.7 |

Tables 11, 12, and 13 below show mean mortality and median mortality results for application of Composition 4 to Anopheles quadrimaculatus female mosquitos at the three field sites.

TABLE 11
Cumulative efficacy data for all spray replicates at
Polk County, FL against Anopheles quadrimaculatus.

| | Mean Mortality¹ | | Median Mortality | |
|---|---|---|---|---|
| Distance | 24-hour | 48-hour | 24-hour | 48-hour |
| 100 ft | 90%^{a} | 100%^{a} | 95% | 100% |
| 200 ft | 75%^{b} | 99%^{a} | 77% | 100% |
| 300 ft | 74%^{b} | 98%^{a} | 75% | 100% |
| Untreated Control | 4%^{c} | 7%^{b} | 4% | 5% |
| (upwind) | | | | |
| Overall Average (at 48 | 99% | | | |
| hours) | | | | |

TABLE 12
Cumulative efficacy data for all spray replicates for Beaufort
County, SC against Anopheles quadrimaculatus.

| | Mean Mortality¹ | | | Median Mortality | | |
|---|---|---|---|---|---|---|
| Distance | 24-hour | 48-hour | 72-hour | 24-hour | 48-hour | 72-hour |
| 100 ft | 65%^{a} | 98%^{a} | 100%^{a} | 69% | 100% | 100% |
| 200 ft | 29%^{b} | 93%^{b} | 100%^{a} | 21% | 96% | 100% |
| 300 ft | 30%^{b} | 92%^{b} | 99%^{a} | 17% | 89% | 100% |
| Untreated Control | 2%^{c} | 4%^{c} | 7%^{b} | 0% | 4% | 5% |
| (upwind) | | | | | | |

| | |
|---|---|
| Overall Average | 99% |
| (at 72 hours) | |

TABLE 13
Cumulative efficacy data for all spray replicates for
Baytown, TX against Anopheles quadrimaculatus.

| | Mean Mortality¹ | | | | Median Mortality | | | |
|---|---|---|---|---|---|---|---|---|
| Distance | 24- hour | 48-hour | 72-hour | 96- hour | 24- hour | 48-hour | 72-hour | 96- hour |
| 100 ft | 69%^{a} | 89%^{a} | 93%^{a} | 94%^{a} | 82% | 100% | 100% | 100% |
| 200 ft | 58%^{b} | 92%^{a} | 98%^{b} | 99%^{b} | 62% | 100% | 100% | 100% |
| 300 ft | 32%^{c} | 92%^{a} | 99%^{b} | 100%^{b} | 33% | 96% | 100% | 100% |
| Untreated Control | 1%^{d} | 3%^{b} | 5%^{c} | 6%^{c} | 0% | 0% | 4% | 4% |
| (upwind) | | | | | | | | |

| | |
|---|---|
| Overall Average | 98% |
| (at 96 hours) | |

With all spray replicates across all locations included in analysis, the average mortality at 72 hours post-spray was 98.0% for spray cages placed 100 feet from the spray line, 99.1% for 200 feet and 98.6% for 300 feet. Across all spray replicates and distances, overall mortality was 98.6%. Control mortality averaged 6.3% at 72 hours. Results are shown in Table 14 below.

TABLE 14
Efficacy of Composition 4 against Anopheles quadrimaculatus female mosquitoes.

| | 24 hours | | 48 hours | | 72 hours | | 96 hours | |
|---|---|---|---|---|---|---|---|---|
| Distance | Mortality | Moribund | Mort. | Mori. | Mort. | Mori. | Mort. | Mori. |
| All | 57.0% | 84.8% | 94.9% | 97.1% | 98.6% | 99.1% | 98.9% | 99.4% |
| 100 | 74.5% | 94.1% | 96.0% | 97.4% | 98.0% | 98.0% | 98.3% | 98.8% |
| 200 | 52.2% | 82.9% | 94.8% | 97.1% | 99.1% | 99.8% | 99.4% | 100% |
| 300 | 44.4% | 77.5% | 93.9% | 96.9% | 98.6% | 99.5% | 98.9% | 99.5% |

| | | | | |
|---|---|---|---|---|
| Control | 2.2% | 4.7% | 6.3% | 6.5% |

3. Tests for Culex quinquefasciatus

Twelve total spray replicates of Composition 4 were performed against Culex quinquefasciatus female mosquitoes for this study. These spray replicates were conducted across four spatially distanced study locations: Polk County, FL, Beaufort County, SC, Maricopa County, A Z, and Baytown, TX.

Droplet size was 14.2 μm at Polk County, FL and Beaufort County, SC, 17.4 μm at Maricopa County, AZ, and 13.7 μm at Baytown, TX.

Volume median diameter (VMD) and droplet densities (drops per square centimeter) were determined for 100 feet, 200 feet, and 300 feet distances following spray of Composition 4. Results are shown in Table 15.

TABLE 15
Droplet data for spray replicates.

| | | | Volume | |
|---|---|---|---|---|
| | | | Median | |
| | | Distance | Diameter | Droplet |
| Site | Location | (ft) | (VMD) | Density |
| Polk | 1 | 100 | 26.3 | 246 |
| County, FL | 2 | 100 | 18.1 | 381.3 |
| A | 3 | 100 | 22.3 | 319.8 |
| | 4 | 200 | 20.3 | 504.3 |
| | 5 | 200 | 23.7 | 180.4 |
| | 7 | 300 | 21.1 | 401.8 |
| | 9 | 300 | 22.5 | 565.8 |
| | Control | n/a | 0 | 0 |
| Polk | 1 | 100 | 17.2 | 1615.3 |
| County, FL | 3 | 100 | 16.3 | 672.4 |
| B | 5 | 200 | 20.2 | 1106.9 |
| | 7 | 300 | 16.9 | 860.9 |
| | 9 | 300 | 17.3 | 643.7 |
| | Control | n/a | 3.9 | 49.2 |
| Polk | 1 | 100 | 18.3 | 512.5 |
| County, FL | 3 | 100 | 18.2 | 778.9 |
| C | 5 | 200 | 19.7 | 205 |
| | 7 | 300 | 15.4 | 272.6 |
| | 8 | 300 | 17.7 | 373.1 |
| | Control | n/a | 3.3 | 6.8 |
| Beaufort | 1 | 100 | 17.3 | 770.7 |
| County, SC | 3 | 100 | 17.7 | 278.8 |
| A | 5 | 200 | 16.9 | 172.2 |
| | 6 | 200 | 16.8 | 83.4 |
| | 7 | 300 | 15.6 | 260.3 |
| | 9 | 300 | 15.3 | 207.0 |
| | Control | n/a | 3.3 | 57.4 |
| Beaufort | 1 | 100 | 18.5 | 169.5 |
| County, SC | 3 | 100 | 16.0 | 147.6 |
| B | 4 | 200 | 17.3 | 102.5 |
| | 5 | 200 | 16.4 | 76.5 |
| | 6 | 200 | 17.4 | 73.8 |
| | 7 | 300 | 19.6 | 91.6 |
| | 8 | 300 | 16.8 | 87.5 |
| | 9 | 300 | 19.9 | 64.2 |
| | Control | n/a | 0.0 | 0 |
| Beaufort | 1 | 100 | 22.3 | 414.1 |
| County, SC | 3 | 100 | 22.2 | 131.2 |
| C | 5 | 200 | 23.1 | 117.5 |
| | 6 | 200 | 18.7 | 116.2 |
| | 8 | 300 | 18.9 | 56.0 |
| | 9 | 300 | 22.4 | 183.1 |
| | Control | n/a | 10.3 | 9.6 |
| Maricopa | 1 | 100 | 18.5 | 251.4 |
| County, AZ | 3 | 100 | 21.7 | 840.4 |
| A | 5 | 200 | 21.0 | 926.5 |
| | 7 | 300 | 19.1 | 243.9 |
| | 8 | 300 | 22.3 | 159.9 |
| | 9 | 300 | 20.2 | 187.2 |
| | Control | n/a | 3.6 | 51.9 |
| Maricopa | 1 | 100 | 20.8 | 153.1 |
| County, AZ | 2 | 100 | 22.5 | 91.6 |
| B | 3 | 100 | 22.5 | 219.3 |
| | 5 | 200 | 20.3 | 975.7 |
| | 7 | 300 | 20.2 | 42.4 |
| | 8 | 300 | 20.0 | 95.7 |
| | 9 | 300 | 19.3 | 280.8 |
| | Control | n/a | 0.0 | 0.0 |
| Maricopa | 1 | 100 | 24.9 | 225.5 |
| County, AZ | 3 | 100 | 20.4 | 254.2 |
| C | 5 | 200 | 17.9 | 297.2 |
| | 7 | 300 | 19.3 | 221.4 |
| | 9 | 300 | 19.7 | 284.9 |
| | Control | n/a | 0.0 | 0.0 |
| Baytown, TX | 1 | 100 | 16.8 | 1041.3 |
| A | 3 | 100 | 19.0 | 701.1 |
| | 5 | 200 | 17.5 | 651.9 |
| | 7 | 300 | 20.7 | 385.4 |
| | 9 | 300 | 21.0 | 504.3 |
| | Control | n/a | 6.3 | 113.4 |
| Baytown, TX | 1 | 100 | 9.9 | 231.6 |
| B | 3 | 100 | 17.9 | 1045.4 |
| | 5 | 200 | 18.3 | 668.3 |
| | 7 | 300 | 12.0 | 594.5 |
| | 9 | 300 | 12.8 | 420.2 |
| | Control | n/a | 5.1 | 195.4 |
| Baytown, TX | 1 | 100 | 17.9 | 754.3 |
| C | 3 | 100 | 16.4 | 819.9 |
| | 5 | 200 | 21.2 | 434.6 |
| | 7 | 300 | 23.2 | 508.4 |
| | 9 | 300 | 17.3 | 446.9 |
| | Control | n/a | 11.8 | 43.7 |

Tables 16, 17, 18 and 19 below show mean mortality and median mortality results for application of Composition 4 to Culex quinquefasciatus female mosquitos at the four field sites.

TABLE 16
Cumulative efficacy data for all spray replicates at
Polk County, FL against Culex quinquefasciatus.

| | Mean Mortality¹ | | | Median Mortality | | |
|---|---|---|---|---|---|---|
| Distance | 24-hour | 48-hour | 72-hour | 24-hour | 48-hour | 72-hour |
| 100 ft | 95%^{a} | 100%^{a} | 100%^{a} | 100% | 100% | 100% |
| 200 ft | 89%^{b} | 100%^{a} | 100%^{a} | 100% | 100% | 100% |
| 300 ft | 85%^{b} | 99%^{a} | 100%^{a} | 88% | 100% | 100% |
| Untreated Control | 1%^{c} | 2%^{b} | 2%^{b} | 0% | 0% | 0% |
| (upwind) | | | | | | |

| | |
|---|---|
| Overall Average | 100% |
| (at 72 hours) | |

TABLE 17
Cumulative efficacy data for all spray replicates for
Beaufort County, SC against Culex quinquefasciatus.

| | Mean Mortality¹ | | | | Median Mortality | | | |
|---|---|---|---|---|---|---|---|---|
| Distance | 24-hour | 48-hour | 72-hour | 96-hour | 24-hour | 48-hour | 72-hour | 96-hour |
| 100 ft | 75%^{a} | 97%^{a} | 100%^{a} | 100%^{a} | 88% | 100% | 100% | 100% |
| 200 ft | 34%^{b} | 87%^{b} | 98%^{b} | 98%^{a} | 29% | 93% | 100% | 100% |
| 300 ft | 29%^{b} | 90%^{b} | 99%^{a} | 99%^{a} | 19% | 92% | 100% | 100% |
| Untreated Control | 0%^{c} | 0%^{c} | 1%^{c} | 1%^{b} | 0% | 0% | 0% | 0% |
| (upwind) | | | | | | | | |

| | |
|---|---|
| Overall Average | 99% |
| (at 96 hours) | |

TABLE 18
Cumulative efficacy data for all spray replicates for
Maricopa County, AZ against Culex quinquefasciatus.

| | Mean Mortality¹ | | | | Median Mortality | | | |
|---|---|---|---|---|---|---|---|---|
| Distance | 24-hour | 48-hour | 72-hour | 96-hour | 24-hour | 48-hour | 72-hour | 96-hour |
| 100 ft | 84%^{a} | 100%^{a} | 100%^{a} | 100%^{a} | 88% | 100% | 100% | 100% |
| 200 ft | 79%^{a} | 99%^{a} | 100%^{a} | 100%^{a} | 80% | 100% | 100% | 100% |
| 300 ft | 40%^{b} | 84%^{b} | 97%^{b} | 98%^{a} | 29% | 90% | 96% | 100% |
| Untreated Control | 3%^{c} | 4%^{c} | 4%^{c} | 6%^{b} | 3% | 4% | 4% | 5% |
| (upwind) | | | | | | | | |

| | |
|---|---|
| Overall Average | 99% |
| (at 96 hours) | |

hours)

TABLE 19
Cumulative efficacy data for all spray replicates
for Baytown, TX against Culex quinquefasciatus.

| | Mean Mortality¹ | | | | Median Mortality | | | |
|---|---|---|---|---|---|---|---|---|
| Distance | 24-hour | 48-hour | 72-hour | 96-hour | 24-hour | 48-hour | 72-hour | 96-hour |
| 100 ft | 63%^{a} | 85%^{a} | 89%^{a} | 90%^{a} | 65% | 95% | 100% | 100% |
| 200 ft | 51%^{b} | 90%^{a} | 99%^{b} | 100%^{b} | 50% | 92% | 100% | 100% |
| 300 ft | 36%^{c} | 83%^{a} | 95%^{b} | 98%^{b} | 42% | 83% | 100% | 100% |
| Untreated Control | 1%^{d} | 3%^{b} | 4%^{c} | 4%^{c} | 0% | 0% | 4% | 4% |
| (upwind) | | | | | | | | |

| | |
|---|---|
| Overall Average | 96% |
| (at 96 hours) | |

With all spray replicates across all locations included in analysis, as can be seen in Table 20, the average mortality at 96 hours post-spray was 97.6% for spray cages placed 100 feet from the spray line, 99.3% for 200 feet and 98.7% for 300 feet. Across all spray replicates and distances, overall mortality was 98.5%. Control mortality averaged 3.3% at 96 hours. If reading were halted at 72 hours, the 72-hour mortality values are included in the 96-hour efficacy averages. Results are shown in Table 20 below.

TABLE 20
Efficacy of CMP132-022 against Culex quinquefasciatus female mosquitoes

| | 24 hours | | 48 hours | | 72 hours | | 96 hours | |
|---|---|---|---|---|---|---|---|---|
| Distance | Mort. | Mori. | Mort. | Mori. | Mort. | Mori. | Mort. | Mori. |
| A11 | 62.9% | 86.5% | 92.5% | 97.1% | 98.0% | 98.4% | 98.5% | 99.0% |
| 100 | 79.1% | 94.8% | 95.4% | 97.1% | 97.4% | 97.5% | 97.6% | 97.9% |
| 200 | 63.6% | 88.8% | 93.7% | 97.6% | 99.0% | 99.7% | 99.3% | 99.9% |
| 300 | 46.6% | 76.1% | 88.7% | 96.8% | 97.8% | 98.2% | 98.7% | 99.2% |

| | | | | |
|---|---|---|---|---|
| Control | 1.4% | 2.2% | 2.7% | 3.3% |

The cage at station 1 at 100 feet in replicate B (B1) at Baytown, TX may have been omitted by the spray cloud, resulting in significantly lower mortality. When the missed station (B1 from Baytown, TX) is removed from analysis, as displayed in Table 21, the overall efficacy across all study locations is 99.3% at 96 hours post-spray. With the missed station removed, mortality by distance is 100%, 99.3% and 98.7% at 100-, 200- and 300 feet respectively at 96 hours post-spray. Again, if reading were halted at 72 hours, the 72-hour mortality values are included in the 96-hour efficacy averages.

TABLE 21
Efficacy of CMP132-022 against Culex quinquefasciatus
female mosquitoes excluding missed stations

| | 24 hours | | 48 hours | | 72 hours | | 96 hours | |
|---|---|---|---|---|---|---|---|---|
| Distance | Mort. | Mori. | Mort. | Mori. | Mort. | Mori. | Mort. | Mori. |
| A11 | 63.4% | 87.2% | 93.4% | 98.0% | 98.9% | 99.3% | 99.3% | 99.7% |
| 100 | 81.2% | 97.4% | 98.0% | 99.8% | 100% | 100% | 100% | 100% |
| 200 | 63.6% | 88.8% | 93.7% | 97.6% | 99.0% | 99.7% | 99.3% | 99.9% |
| 300 | 46.6% | 76.1% | 88.7% | 96.8% | 97.8% | 98.2% | 98.7% | 99.2% |

| | | | | |
|---|---|---|---|---|
| Control | 1.4% | 2.2% | 2.7% | 3.3% |

4. Tests for Aedes aegypti—High Rate

Three total spray replicates of Composition 4 were performed against Aedes aegypti female mosquitoes for this study. These spray replicates were conducted at Baytown, TX.

Droplet size was 18.1 μm and applied at a rate of 1.5 fl. oz/acre.

Volume median diameter (VMD) and droplet densities (drops per square centimeter) were determined for 100 feet, 200 feet, and 300 feet distances following spray of Composition 4. Results are shown in Table 22.

TABLE 22
Droplet data for spray replicates from Baytown, TX

| | | | Volume | |
|---|---|---|---|---|
| | | | Median | |
| | | Distance | Diameter | Droplet |
| Replicate | Location | (ft) | (VMD) | Density |
| A | 1 | 100 | 19.7 | 2226.1 |
| | 3 | 100 | 17.5 | 2205.6 |
| | 5 | 200 | 21.8 | 2103.2 |
| | 7 | 300 | 20.3 | 1947.4 |
| | 9 | 300 | 20.9 | 1406.2 |
| | Control | n/a | 7.4 | 57.4 |
| B | 1 | 100 | 22.3 | 3718.4 |
| | 3 | 100 | 21.5 | 1742.4 |
| | 5 | 200 | 18.9 | 2263.0 |
| | 7 | 300 | 20.0 | 1836.7 |
| | 9 | 300 | 18.9 | 1635.8 |
| | Control | n/a | 4.8 | 103.9 |
| C | 1 | 100 | 21.5 | 3132.2 |
| | 3 | 100 | 16.8 | 356.7 |
| | 5 | 200 | 17.5 | 1406.2 |
| | 7 | 300 | 16.0 | 1328.3 |
| | 9 | 300 | 15.0 | 1951.5 |
| | Control | n/a | 5.6 | 116.2 |

Table 23 below shows mean mortality and median mortality results for application of Composition 4 to Aedes aegypti female mosquitos at the field site.

TABLE 23
Cumulative efficacy data for all spray replicates for Baytown,
TX against Aedes aegypti high rate (1.5 fl. oz/acre).

| | Mean Mortality¹ | | | Median Mortality | | |
|---|---|---|---|---|---|---|
| Distance | 24-hour | 48-hour | 72-hour | 24-hour | 48-hour | 72-hour |
| 100 ft | 79%^{a} | 100%^{a} | 100%^{a} | 75% | 100% | 100% |
| 200 ft | 80%^{a} | 100%^{a} | 100%^{a} | 77% | 100% | 100% |
| 300 ft | 83%^{a} | 99%^{a} | 100%^{a} | 82% | 100% | 100% |
| Untreated Control | 5%^{b} | 6%^{b} | 6%^{b} | 4% | 4% | 4% |
| (upwind) | | | | | | |

| | |
|---|---|
| Overall Average | 100% |
| (at 72 hours) | |

### Exemplary Embodiments

For reasons of completeness, various aspects of the technology are set out in the following numbered embodiments:
Embodiment 1. An insecticidal composition comprising:
   an active ingredient including a meta-diamide;
   a solvent system including a tricarboxylate solvent and a second solvent; and a surfactant.
Embodiment 2. The insecticidal composition according to Embodiment 1, wherein the insecticidal composition includes, by weight percentage, 1% to 20% surfactant.
Embodiment 3. The insecticidal composition according to Embodiment 1 or Embodiment 2, wherein the insecticidal composition includes, by weight percentage, 0.1% to 6.0% active ingredient.
Embodiment 4. The insecticidal composition according to any one of Embodiments 1-3, wherein the insecticidal composition includes, by weight percentage, 0.25% to 3.0% active ingredient.
Embodiment 5. The insecticidal composition according to any one of Embodiments 1-4, wherein the insecticidal composition includes, by weight percentage, 0.5% to 1.5% active ingredient.
Embodiment 6. The insecticidal composition according to any one of Embodiments 1-5, wherein the second solvent is a polyalkylene carbonate.
Embodiment 7. The insecticidal composition according to Embodiment 6, wherein the second solvent is ethylene carbonate, propylene carbonate, or butane carbonate.
Embodiment 8. The insecticidal composition according to any one of Embodiments 1-7, wherein the second solvent is a pentanoic acid.
Embodiment 9. The insecticidal composition according to any one of Embodiments 1-7, wherein the second solvent is methyl 5-(dimethylamino)-2-methyl-5-oxopentanoate.
Embodiment 10. The insecticidal composition according to any one of Embodiments 1-9, wherein the surfactant is an alkoxylated alcohol.
Embodiment 11. The insecticidal composition according to Embodiment 11, wherein the alkoxylated alcohol is a C₉-C₁₁ alcohol ethoxylate/propoxylate.
Embodiment 12. The insecticidal composition according to any one of Embodiments 1-11, wherein the metadiamide is isocycloseram.
Embodiment 13. The insecticidal composition according to any one of Embodiments 1-12, wherein the metadiamide is broflanilide.
Embodiment 14. The insecticidal composition according to any one of Embodiments 1-13, wherein a ratio of tricarboxylate solvent to second solvent is from 0.67:1 to 1.5:1.
Embodiment 15. The insecticidal composition according to any one of Embodiments 1-14, wherein the insecticidal composition has a density of from about 1.0 g/mL to about 1.2 g/mL.
Embodiment 16. The insecticidal composition according to any one of Embodiments 1-15, wherein the insecticidal composition has a minimum viscosity between 0.9 centistokes (cts) to 1.1 centistokes (cts).
Embodiment 17. A method, comprising:
   emitting an ultra-low volume (ULV) insecticidal composition, the ULV insecticidal composition comprising:
      an active ingredient including a meta-diamide;
      a solvent system including a tricarboxylate solvent and a polyalkylene solvent; and
      a surfactant.
Embodiment 18. The method according to Embodiment 17, wherein the insecticidal composition includes, by weight percentage, 1% to 10% surfactant; and
   wherein the insecticidal composition includes, by weight percentage, 0.1% to 6.0% active ingredient.
Embodiment 19. The method according to Embodiment 17 or Embodiment 18, wherein the surfactant is an alkoxylated alcohol; and
   wherein the metadiamide is broflanilide.
Embodiment 20. The method according to any one of Embodiments 17-19, wherein a ratio of tricarboxylate solvent to second solvent is from 0.67:1 to 1.5:1

The foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

1. An insecticidal composition comprising:
an active ingredient including a meta-diamide;
a solvent system including a tricarboxylate solvent and a second solvent; and
a surfactant.

2. The insecticidal composition according to claim 1, wherein the insecticidal composition includes, by weight percentage, 1% to 20% surfactant.

3. The insecticidal composition according to claim 2, wherein the insecticidal composition includes, by weight percentage, 0.1% to 6.0% active ingredient.

4. The insecticidal composition according to claim 3, wherein the insecticidal composition includes, by weight percentage, 0.25% to 3.0% active ingredient.

5. The insecticidal composition according to claim 4, wherein the insecticidal composition includes, by weight percentage, 0.5% to 1.5% active ingredient.

6. The insecticidal composition according to claim 1, wherein the second solvent is a polyalkylene carbonate.

7. The insecticidal composition according to claim 6, wherein the second solvent is ethylene carbonate, propylene carbonate, or butane carbonate.

8. The insecticidal composition according to claim 1, wherein the second solvent is a pentanoic acid.

9. The insecticidal composition according to claim 8, wherein the second solvent is methyl 5-(dimethylamino)-2-methyl-5-oxopentanoate.

10. The insecticidal composition according to claim 1, wherein the surfactant is an alkoxylated alcohol.

11. The insecticidal composition according to claim 10, wherein the alkoxylated alcohol is a C₉-C₁₁ alcohol ethoxylate/propoxylate.

12. The insecticidal composition according to claim 1, wherein the meta-diamide is isocycloseram.

13. The insecticidal composition according to claim 1, wherein the meta-diamide is broflanilide.

14. The insecticidal composition according to claim 1, wherein a ratio of tricarboxylate solvent to second solvent is from 0.67:1 to 1.5:1.

15. The insecticidal composition according to claim 1, wherein the insecticidal composition has a density of from about 1.0 g/mL to about 1.2 g/mL.

16. The insecticidal composition according to claim 1, wherein the insecticidal composition has a minimum viscosity between 0.9 centistokes (cts) to 1.1 centistokes (cts).

17. A method, comprising:
emitting an ultra-low volume (ULV) insecticidal composition, the ULV insecticidal composition comprising:
an active ingredient including a meta-diamide;
a solvent system including a tricarboxylate solvent and a polyalkylene solvent; and
a surfactant.

18. The method according to claim 17, wherein the insecticidal composition includes, by weight percentage, 1% to 10% surfactant; and
wherein the insecticidal composition includes, by weight percentage, 0.1% to 6.0% active ingredient.

19. The method according to claim 18, wherein the surfactant is an alkoxylated alcohol; and
wherein the meta-diamide is broflanilide.

20. The method according to claim 19, wherein a ratio of tricarboxylate solvent to second solvent is from 0.67:1 to 1.5:1.
